(19) United States
(12) Patent Application Publication
(10) Pub. No.: US 2011/0303010 A1
(43) Pub. Date: Dec. 15, 2011

(54) MEMS THREE-AXIS ACCELEROMETER

(76) Inventor: Bin Yang, Shenzhen (CN)

(21) Appl. No.: 13/016,172

(22) Filed: Jan. 28, 2011

(30) Foreign Application Priority Data
Jun. 11, 2010 (CN) 201010198622.1

(51) Int. Cl. G01P 15/125

(52) U.S. Cl. 73/514.32

(57) ABSTRACT

A MEMS three-axis accelerometer includes a silicon substrate, a first electrode and a second electrode etched in the same silicon substrate. The first electrode is constituted by a mobile mass fitted with a plurality of mobile fingers extending laterally. The second electrode is composed of two conductive parts located on two opposite sides of the mobile mass. Each conductive part comprises a plurality of fixed fingers formed parallel to the mobile fingers. Each mobile finger is positioned between two contiguous fixed fingers to cooperatively form a microstructure with interdigital combs. The mobile mass is connected to the substrate by a spring.

### FIELD OF THE INVENTION

The disclosure relates to Micro Electro Mechanical Systems (MEMS) devices, and more particularly to a MEMS three-axis accelerometer.

### RELATED ART OF THE INVENTION

MEMS accelerometers are widely used in different areas for detecting the acceleration or orientation of a device such as vehicles, hand-held devices, aircrafts or hand-based devices. They are also used in vehicles to sense impacts and deploy various devices to protect the passengers (for example, air bags in automobiles). The MEMS accelerometers may be required to sense acceleration or other phenomena along one, two, or three axes or directions. From this information, the movement or orientation of the device can be ascertained.

In the ongoing effort to reduce the size and cost of the accelerometers, a variety of accelerometers have been proposed. Accelerometers include capacitive structure, some of which are constructed using semi-conductor manufacturing type methods, such as of photoresists, masks and various etching processes. The capacitive structures generally consist of at least one conductive plate, formed of doped silicon or the like, which is mounted on a substrate by way of a compliant suspension. The plate is positioned parallel to a planar surface of the substrate and forms capacitances with fixed structures mounted on the substrate. When the plate moves due to acceleration, the capacitances between the plate and these fixed structures changes. These changes are then sensed by the electronic circuitry of the accelerometer and are converted to signals representative of the acceleration. However, the accelerometers mentioned above have inherent limitations on the minimum size, detection limit, sensitivity and the like.

Therefore, it is desirable to provide a MEMS three-axis accelerometer which can overcome the above-mentioned problems.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments.

FIG. 1 is an illustrative isometric view of a MEMS three-axis accelerometer, in accordance with an exemplary embodiment, from which a substrate of the MEMS here-axis accelerometer is removed.

FIG. 2 is a top view of the MEMS three-axis accelerometer of FIG. 1;

FIG. 3 is a cross-section view of the MEMS three-axis accelerometer taken along line III-III of FIG. 1.

### DETAILED DESCRIPTION OF THE EXEMPLARY EMBODIMENT

Reference will now be made to describe the exemplary embodiment of the present disclosure in detail.

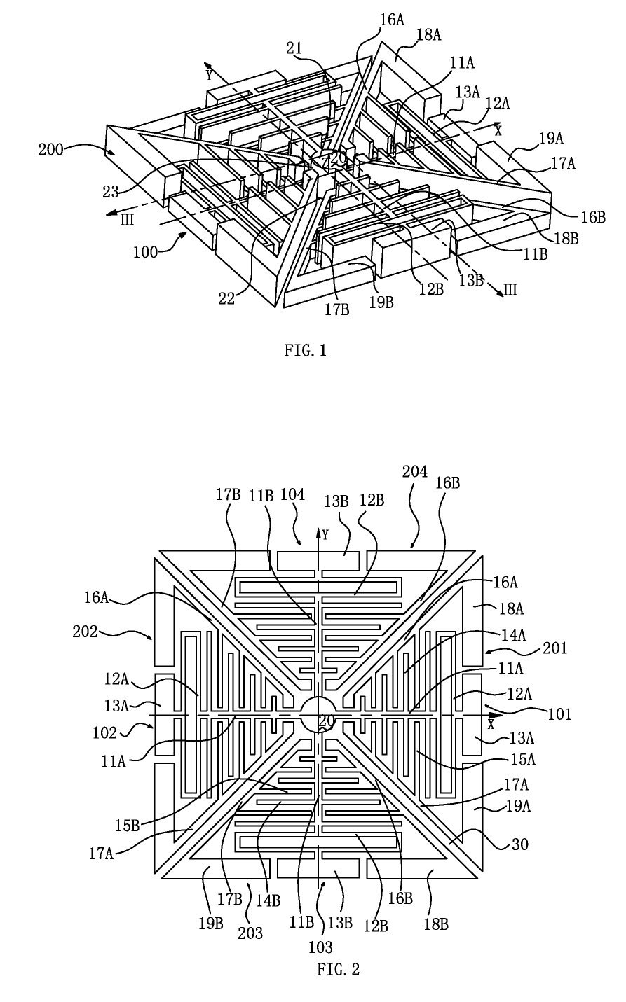

Referring to FIGS. 1-3, a MEMS three-axis accelerometer, in accordance with an exemplary embodiment, is provided for measuring acceleration in three mutually orthogonal axis, a first axes X, a second axes Y and a third axes Z. The accelerometer comprises a silicon substrate (not shown), a movable electrode 100 positioned relative to the silicon substrate and a plurality of fixed electrodes 200 fixed relative to the substrate. The movable electrode 100 comprises a mobile mass 20 on the central portion thereof The mobile mass 20 is a column configuration and is etched in the silicon substrate.

The mobile mass 20 defines an upper surface 21, a lower surface 22 opposite to the upper surface, and a sidewall 23 sandwiched between the upper surface 21 and the lower surface 22. A plurality of first sensitive parts is extending from the sidewall 23 of the mobile mass 20. In the present embodiment, two first sensitive parts 101, 102 are anchored to the silicon substrate by a first spring 12A. The first spring 12A is connected to a first mobile anchor 13A. Each first sensitive part includes a first mobile beam 11A along the first axes X and a plurality of mobile fingers 14A extending from two opposite sides of the first mobile beams 11A. The mobile fingers 14A are symmetrical about the first mobile beams 11A. The first sensitive part defines a first mobile upper surface 141A parallel to the upper surface 21, and a first mobile lower surface 142A opposite to the first mobile upper surface 141A. Meanwhile, a plurality of second sensitive parts is extended from the sidewall 23 of the mobile mass 20 along the second axes Y perpendicular to the first axes X. In the present embodiment, two second sensitive parts 103, 104 are anchored to the silicon substrate by a second spring 12B. The second spring 12B connects to a second mobile anchor 13B. Each first sensitive part includes a second mobile beam 11B along the second axes Y and a plurality of mobile fingers 14B extending from two opposite sides of the second mobile beam 11B. The mobile fingers 14B are formed symmetrical about the second mobile beam 11B. The second sensitive part defines a second mobile upper surface 141B parallel to the upper surface 21, and a second mobile lower surface 142B opposite to the second mobile upper surface 141B.

The fixed electrode 200 comprises a plurality of first fixed sensitive parts and a plurality of second fixed sensitive parts arranged along the first axes X and the second axes Y, respectively. In the present embodiment, two first fixed sensitive parts 201, 202 and two second fixed sensitive parts 203, 204 are provided to form the silicon substrate. Each first fixed sensitive parts 201, 202 comprises a pair of first fixed beam 16A, 17A respectively located in two opposite sides of the first mobile beam 11A. A plurality of first fixed fingers 15A is extended from the first fixed beams 16A, 17A and parallel to the first mobile fingers 14A. The first fixed finger 15A and the first mobile finger 14A is overlaid with polysilicon. The two first fixed beams 16A, 17A are anchored to the silicon substrate by the corresponding first fixed anchors 18A, 19A, thereby each first mobile finger 14A is positioned between two contiguous corresponding first fixed fingers 15A to cooperatively form a microstructure with interdigital combs. Each second fixed sensitive parts 203, 204 comprises a pair of second fixed beam 16B, 17B respectively located in two opposite sides of the second mobile beam 11B, a plurality of second fixed fingers 15B extending from the second fixed beams 16B, 17B and parallel to the second mobile fingers 14B. The second fixed finger 15B and the second mobile finger 14B is overlaid with polysilicon. The second fixed beams 16B, 17B are anchored to the silicon substrate by the corresponding second fixed anchors 18B, 19B, thereby each second mobile finger 14B is positioned between two contiguous corresponding second fixed fingers 15B to cooperatively form another microstructure with interdigital combs.

In the present embodiment, each pair of first fixed anchors 18A,19A is formed symmetrical about the first mobile anchor 13A while each pair of second fixed anchors 18B,19B is formed symmetrical about the second mobile anchor 13B.

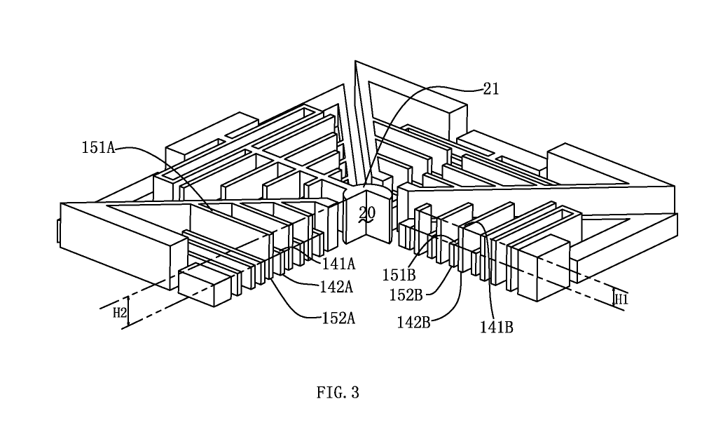

Referring to FIG. 3, The first fixed fingers 15A defines a first fixed upper surface 151A parallel to the upper surface 21, and a first fixed lower surface 152A opposite to the first fixed upper surface 151A, a distance H2 between the first mobile upper surface 141A and the upper surface 21 of the mobile mass 20 is longer than the distance between the first fixed upper surface 151A and the upper surface 21 of the mobile mass 20. The second fixed fingers 15B defines a second fixed upper surface 151B parallel to the upper surface 21, and a second fixed lower surface 152B opposite to the second fixed upper surface 151B, a distance H1 between the second mobile upper surface 141B and the upper surface 21 of the mobile mass 20 is shorter than the distance between the second fixed upper surface 151B and the upper surface 21 of the mobile mass 20. Moreover, a height of the first fixed upper surface 151A is same as that of the second mobile upper surface 141B along the third axes Z.

A gap 30 is formed between the first fixed beam 17A and the second fixed beam 16B. The gap 30 has an even width between the first fixed beam 17A and the second fixed beam 16B.

The first spring 12A drives the mobile mass 20 to move along the first axes X parallel to the upper surface 21 of the mobile mass 20, and the second spring 12B drives the mobile mass 20 to move along the second axes Y perpendicular to the first axes X and parallel to the upper surface 21 of mobile mass 20. And the first and second springs 12A, 12B drive the mobile mass 20 to shift along the third axes Z perpendicular to the first and second axes X and Y.

When the mobile mass 20 is driven by an acceleration and moves along the first axes X, a distance between the first mobile finger 14A and the corresponding fixed finger 15A is changed, and as a result, the MEMS three-axis accelerometer can sense and orient a motion along the first axis X according to the variances of the capacitance value between the first fixed finger 15A and the corresponding first mobile finger 14A. In the same way, when the mobile mass 20 is driven to move along the second axes Y by an acceleration, a distance between the second mobile finger 14B and the corresponding second fixed finger 15B is changed, thereby the MEMS three-axis accelerometer can sense and orient a motion along the second axes

Y according to the variances of the capacitance value between the second fixed finger 15B and the second mobile finger 14B. Furthermore, when the mobile mass 20 is driven by an acceleration and moves along the third axes Z, the overlapping area of the first and second mobile fingers 14a, 14B and the corresponding first and second fixed fingers 15A, 15B are also changed, thereby the MEMS three-axis accelerometer can sense and orient a motion along the third axes according to the variances of the capacitance values between the first and second fixed fingers 15a, 15B and the corresponding mobile fingers 14a, 14B.

With the configuration of the above mentioned, a compact, three-axis accelerometer is obtained, and simultaneously, the sensitivity of the accelerometer is effectively enhanced.

While the present invention has been described with reference to a specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A MEMS three-axis accelerometer comprising:
a silicon substrate;
a mobile mass anchored to the substrate, and defining an upper surface, a lower surface opposite to the upper surface and a sidewall sandwiched between the upper surface and the lower surface;
a plurality of first mobile fingers extending from the mobile mass and connected to the silicon substrate via a first spring along a first axes and the first axes perpendicular to the sidewall;
a plurality of first fixed fingers formed parallel to the first mobile fingers, each first fixed finger formed between two adjacent first mobile fingers, the first mobile fingers cooperative with the first fixed fingers to form a comb capacitor;
a plurality of second mobile fingers extending from the mobile mass and connected to the silicon substrate via a second spring along a second axes, and the second axes perpendicular to the first axes;
a plurality of second fixed fingers parallel to the second mobile fingers, each second fixed finger formed between two adjacent second mobile fingers, the second mobile fingers cooperative with the second fixed fingers to form a comb capacitor; wherein
the first mobile fingers defines a first mobile upper surface, a first mobile lower surface opposite to the first mobile upper surface and the first mobile upper surface parallel to the upper surface, while the first fixed fingers defines a first fixed upper surface parallel to the upper surface, and a first fixed lower surface opposite to the first fixed upper surface; a distance between the first mobile upper surface and the upper surface of the mobile mass is longer than the distance between the first fixed upper surface and the upper surface;
the second mobile fingers defines a second mobile upper surface parallel to the upper surface, a second mobile lower surface opposite to the second mobile upper surface; while the second fixed fingers defines a second fixed upper surface parallel to the upper surface, and a second fixed lower surface opposite to the second fixed upper surface; a distance between the second mobile upper surface and the upper surface of the mobile mass is shorter than the distance between the second fixed upper surface and the upper surface of the mobile mass;
the first fixed finger and the first mobile finger is overlaid, while the second finger and the second mobile finger is overlaid.

2. The MEMS three-axis accelerometer as described in claim 1 further defining a first mobile beam having two opposite sides for providing the first mobile fingers and a second mobile beam having two opposite sides for providing the second mobile fingers.

3. The MEMS three-axis accelerometer as described in claim 2 further defining a first mobile anchor formed on the first axes, a first spring connected to the first mobile anchor for anchoring the first mobile beam to the silicon substrate, a second mobile anchor formed on the second axes, and a second spring connected to the second mobile anchor for anchoring the second mobile beam to the silicon substrate.

4. The MEMS three-axis accelerometer as described in claim 2, wherein the first mobile fingers are symmetrical about the first mobile beams and the second mobile fingers are symmetrical about the second mobile beams.

5. The MEMS three-axis accelerometer as described in claim 3 further defining a pair of first fixed beams respectively located in two opposite sides of the first mobile beam and a pair of second fixed beams respectively located in two opposite sides of the second mobile beam.

6. The MEMS three-axis accelerometer as described in claim 5 further defining a first fixed anchor connected to the first fixed beam anchor to the silicon substrate and a second fixed anchor connected to the second fixed beam anchor to the silicon substrate.

7. The MEMS three-axis accelerometer as described in claim 5 further defining a gap formed between the first fixed beam and the second fixed beam.

8. The MEMS three-axis accelerometer as described in claim 1 further defining a third axes perpendicular to the first and second axes; a height of the first fixed upper surface is same as that of the second mobile upper surface along the third axes.
